(19) United States
(12) Patent Application Publication
(10) Pub. No.: US 2016/0071193 A1
(43) Pub. Date: Mar. 10, 2016

(54) TERMINAL DEVICE FOR SHOWING DIRECTION TO PRODUCT AND METHOD THEREFOR

(71) Applicant: Samsung Electro-Mechanics Co., Ltd., Suwon-si (KR)

(72) Inventors: Hyung Jin IM, Suwon-si (KR); Chin Tae YANG, Suwon-si (KR); Jong Heum PARK, Suwon-si (KR)

(73) Assignee: SAMSUNG ELECTRO-MECHANICS CO., LTD., Suwon-si (KR)

(21) Appl. No.: 14/723,939

(22) Filed: May 28, 2015

(30) Foreign Application Priority Data
Sep. 10, 2014 (KR) 10-2014-0119620

(51) Int. Cl. G06Q 30/06; H04W 4/00; H04W 4/04

(52) U.S. Cl. CPC G06Q 30/0639; H04W 4/04; H04W 4/008

(57) ABSTRACT

A terminal device for providing location information of a product of interest in a store. The terminal device includes a communicator configured to communicate with the repeaters; a display configured to display information visibly; a storage module configured to store the information; a product location searcher configured to generate a message to request search for a location of a product of interest based on received product search information that is input by a user, transmit the message to the lighting management server through the repeater, and receive product location information that is specified as a location of a lighting device in proximity to the product of interest through the repeater; and a controller configured to generate product-location-representation information that displays an overlay of the received product location on a map and display the generated information on the display.

### CROSS-REFERENCE TO RELATED APPLICATION(S)

This application claims priority from Korean Patent Application No. 10-2014-0119620, filed on Sep. 10, 2014, in the Korean Intellectual Property Office, the disclosure of which is incorporated herein by reference in its entirety.

### BACKGROUND

1. Field

The following description relates to a terminal device for providing location information of a product displayed in a store.

2. Description of the Related Art

Generally, it is not easy to find a product of interest in a large store, so customers usually reach a store manager or information officer for inquiries relating to the locations of products. In view of store management, guiding individual customers in the large store to the products that the customers are looking for may incur substantial expenses.

In the store, lighting devices are managed by a server by communicating with the server via repeaters. The lighting devices managed through the same repeater may be grouped together. In such a manner, a plurality of lighting devices in the store may be divided into groups and information relating to lighting devices may be managed in groups.

### SUMMARY

The following description relates to a terminal device which provides a location of a product of interest in a store. In addition, the following description relates to a terminal device which provides a path from a current location of the terminal device to a location of a product of interest, and a method therefor.

The terminal device and method for showing a direction to a product of interest can reduce time spent searching for a desired product, thereby allowing customers to shop more products in the store.

In one general aspect, there is provided a terminal device includes a communicator, a display, a storage module, a product location searcher, and a controller. The terminal device provides product location information in association with a lighting management system that includes a plurality of groups of lighting devices, a plurality of repeaters that establish near-field communications with the respective groups of lighting devices, and a lighting management server that controls the lighting devices through the repeaters.

The controller may further include a terminal location calculator and a path display.

The terminal location calculator may compute the current location of the terminal device through triangulation using a wireless communication with at least two repeaters.

The terminal device may further include a near-field communicator configured to communicate with the lighting devices in a store. The terminal location calculator may obtain identification information of lighting device through the near-field communicator, acquire location information of the lighting device based on the obtained identification information and compute the current location of the terminal device based on the acquired location information of the lighting device.

The near-field communicator may be at least one of following modules: NFC, WiFI, and ZigBee modules.

Other features and aspects will be apparent from the following detailed description, the drawings, and the claims.

### BRIEF DESCRIPTION OF THE DRAWINGS

FIG. 1 is a diagram illustrating a configuration of a lighting management system according to an exemplary embodiment.

FIG. 2 is a block diagram illustrating a terminal device according to an exemplary embodiment.

FIG. 3 is a diagram illustrating an example of arrangement of lighting devices in a store.

FIG. 4 is a diagram illustrating an example of a method of guiding the location of a product of interest.

FIG. 5 is a diagram illustrating an example method of a terminal device to estimate a current location thereof.

FIG. 6 is a diagram illustrating another example method of a terminal device to estimate a current location thereof.

FIG. 7 is a flowchart illustrating a method of showing a direction to a product of interest according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

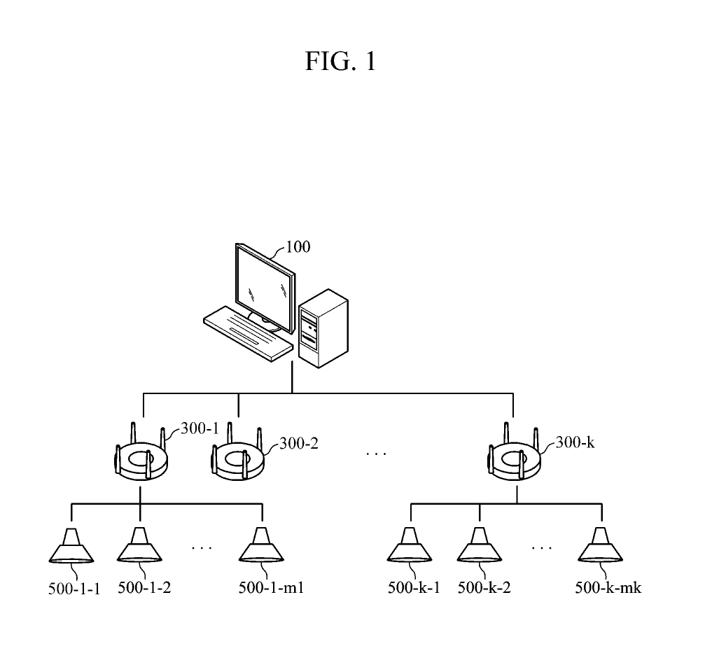

FIG. 1 is a diagram illustrating a configuration of a lighting management system according to an exemplary embodiment.

Referring to FIG. 1, the lighting management system may include a plurality of lighting devices 500, which are divided into a number of groups; a plurality of repeaters or gateways 300 that respectively establish a near-field communication with the groups of lighting devices; and a lighting management server 100 that controls the lighting devices through the repeaters.

The lighting management server 100 communicates with the plurality of lighting devices 500-1-1, 500-1-2, 500-1-m1, 500-k-1, 500-k-2, . . . , and 500-k-mk via the repeaters 300-1, 300-2, . . . , and 300-k. The plurality of lighting devices 500-1-1, 500-1-2, 500-1-m1, 500-k-1, 500-k-2, . . . , and 500-k-mk are divided into groups and managed in groups. The lighting management server 100 is connected to the repeaters 300-1, 300-2, . . . , and 300-k via a cable network.

The lighting management server 100 compiles location information of each product, relative to locations of lighting devices, into a database, and manages the database. More specifically, the management server 100 manages matching information between a location of a lighting device and a location of a display shelf. An identification number of a product is matched with an identification number of a lighting device, and the location of the lighting device is determined by the identification number thereof. Therefore, once the identification number of a product is known, it is possible to obtain a matched identification number of a lighting device, whereby the location of the lighting device can be identified. That is, once the location of the lighting device is identified, the location of the display shelf matched with the lighting device is also identified, so that a customer can find where the product of interest is located.

Here, the lighting management server 100 may include database that stores lighting information required for system operation and management information thereof and middle ware that connects and relays external devices and the database.

The repeaters 300 relay information between the lighting device 500 and the lighting management server 100. Here, each repeater 300-1, 300-2, . . . , and 300-k are connected to the lighting management server 100 over a cable network, such as Ethernet. The repeaters 300-1, 300-2, . . . , and 300-k are respectively connected to the groups of the lighting devices 500-1-1, 500-1-2, 500-1-m1, 500-k-1, 500-k-2, . . . , and 500-k-mk wirelessly. For example, the repeaters 300-1, 300-2, . . . , and 300-k may be connected to the lighting devices 500-1-1, 500-1-2, 500-1-m1, 500-k-1, 500-k-2, . . . , and 500-k-mk via a wireless network, such as WiFi or ZigBee network. The repeaters 300-1, 300-2, . . . , and 300-k may be access points (APs) or ZigBee gateways.

The lighting device 500 may be managed by the lighting management server 100 through the repeaters 300. In the case where the repeaters 300-1, 300-2, . . . , and 300-k are connected to the lighting devices 500-1-1, 500-1-2, 500-1-m1, 500-k-1, 500-k-2, . . . , and 500-k-mk via a wireless network, the lighting devices 500-1-1, 500-1-2, 500-1-m1, 500-k-1, 500-k-2, . . . , and 500-k-mk may be light-emitting diode (LED) lighting devices with communication integrated circuit (IC) for wireless control embedded therein. For example, the repeaters 300-1, 300-2, . . . , and 300-k may be connected to the lighting devices 500-1-1, 500-1-2, 500-1-m1, 500-k-1, 500-k-2, . . . , and 500-k-mk via a wireless network, such as WiFi, Bluetooth® or ZigBee network. However, when necessary, they may be connected to each other via a cable network.

The LED lighting device is a lighting device using LED elements that emit light when electricity is applied. Light of various colors can be generated using the light emission principle of LEDs, which consume less energy than the existing lighting devices. A communication module may be embedded in each LED lighting device for communication with the repeater.

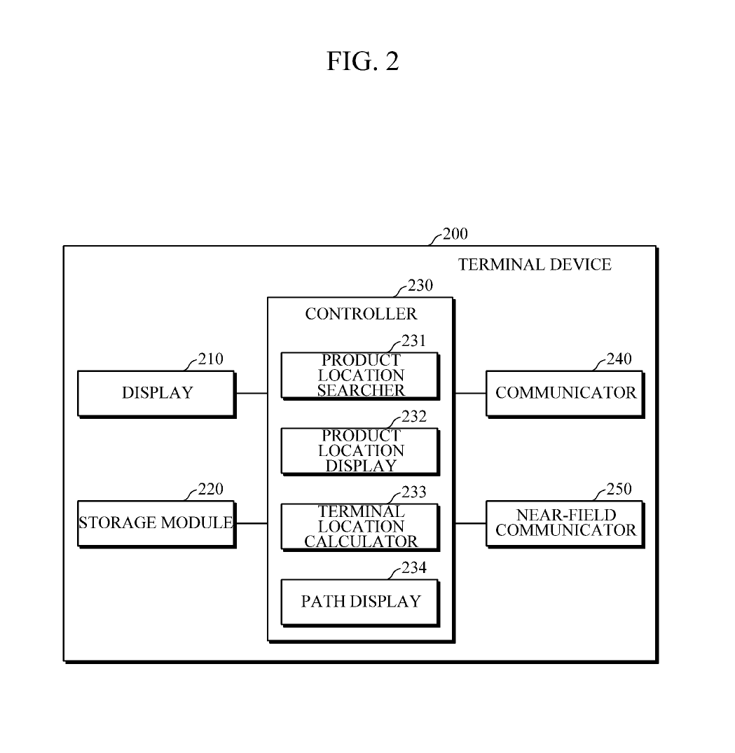

FIG. 2 is a block diagram illustrating a terminal device according to an exemplary embodiment.

Referring to FIG. 2, terminal device 200 provides product location information in association with a lighting management system. The terminal device 200 may include a display 210, a storage module 220, a controller 230, and a communicator 240. The configuration illustrated in FIG. 2 is only exemplary, and the terminal device 200 may include only some modules among the aforementioned modules, and/or further include other modules required for specific operations.

The display 210 provides information in visible form. For example, the display 210 may be a device that includes a liquid crystal display (LCD), a plasma display panel (PDP), a cathode-ray tube (CRT), and the like.

The storage module 220 stores information. System operating programs, transient data, and information received from a repeater 300 (refer to FIG. 1). For example, the storage module may be a storage medium, including memory, a hard disk drive (HDD), and the like.

The communicator 240 communicates with the repeater 300. In the exemplary embodiment, the communicator 240 may be a WiFi or ZigBee communication module.

The controller 230 may include a product location searcher 231 and a product location display 232.

The product location searcher 231 generates a product location search request message from product search information input by a user, transmits the product location search request message to the lighting management server 100 through the repeater 300, and receives product location information that is specified as a location of a lighting device in proximity of the product of interest. Here, the product search information refers to information that is input by the user to identify a location of a product of interest in a store. The product search information may be a product name or search keyword to search for the product of interest. For example, if the user wants to identify a location of milk of a particular brand in the store, the product search information may be a specific product name from said particular brand. In addition, the product search information may be “milk.” The particular product name is matched with an identification number of the products and the matching result is managed.

The lighting management server 100 may manage matching information between locations of lighting devices and locations of nearby display shelves, and match identification numbers of products with identification numbers of lighting devices, wherein the locations of lighting devices are determined by the identification numbers thereof. Therefore, once an identification number of a particular product is known, it is possible to obtain a matched identification number of a lighting device, whereby the location of the lighting device can be identified. That is, once the location of the lighting device is identified, the location of the display shelf matched with the lighting device is also identified, so that the user can find where the product of interest is located.

The product location display 232 may generate product-location-representation information to be displayed as an overlay on a map regarding the received product location, and display the generated information on the display 210. For example, the product-location-representation information may indicate the location of the product of interest by flashing an image of the lighting device matched with said products on the map. In addition, the product-location-representation information may indicate the location of the product of interest by displaying the image of the matched lighting device to be larger than other lighting device images. However, a method of displaying the product location is not limited thereto, and any methods that can make the location of the particular product of interest distinguishable on the map may be used.

In one example, the controller 230 of the terminal device may further include a terminal location calculator 233 and a path display 234.

The terminal location calculator 233 obtains information about a current location of the terminal device 200. More specifically, the terminal location calculator 233 obtains the current location of the terminal device 200 from an indoor positioning system (IPS) and displays the obtained location. The IPS refers to a location checking/tracking system that can be utilized in a limited space, such as a near field or an indoor space. A method for estimating the current location of the terminal device 200 is not limited, and may use any known indoor positioning algorithm.

An indoor positioning method may be classified into three categories according to the wireless communication technology used: triangulation-based; proximity-based; and location-fingerprint-based methods. The triangulation-based method estimates a location of interest using a distance among three points. The proximity-based method includes a method of monitoring a wireless access point to recognize if a target object to be tracked is within coverage of one or more access points in a wireless cell network and a method of calling for information of a tag or automatic identification system, identifying the tag or system and estimating the location. The location-fingerprint-based method arbitrarily selects multiple locations using a fingerprint mechanism, and estimates a location of interest using information about signal intensities collected from the selected locations.

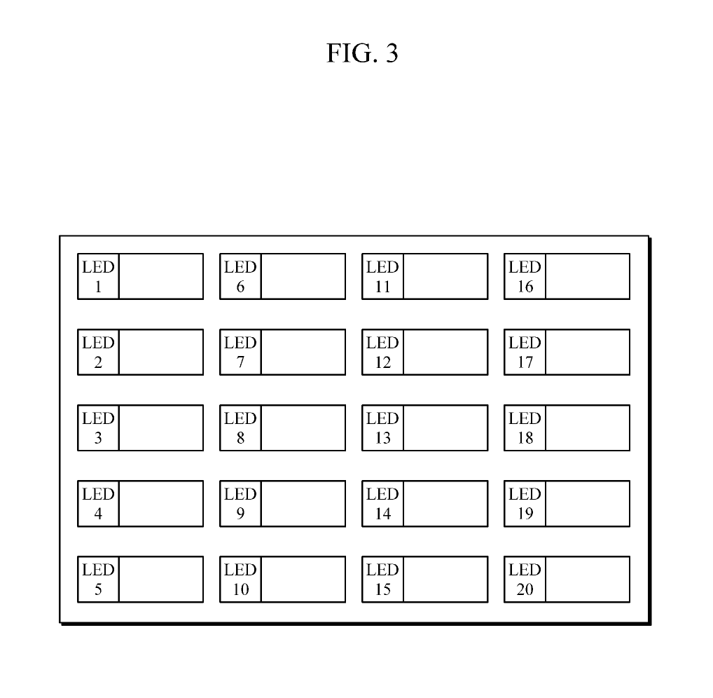

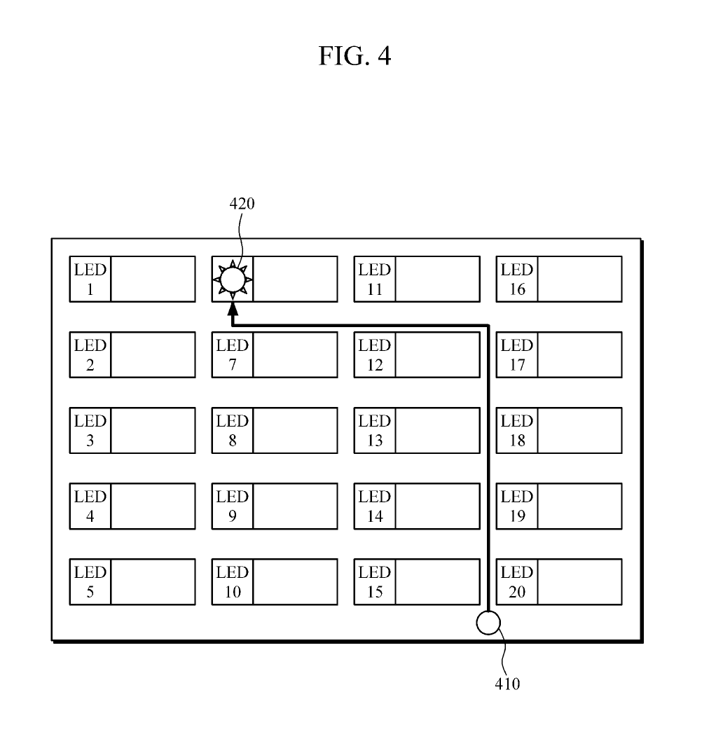

The path display 234 computes a path from the product location received from the product location searcher 231 to the current location of the terminal received from the terminal location calculator 233, generates an image to represent the computed path, and outputs the image to the display 220. For example, the path between the product location and the current location of the terminal may be depicted as a solid-line arrow starting from the current location of the terminal to the location of the product. The path may be the shortest path between the two locations. However, a method for representing the path from the origin to the destination is not limited thereto, such that any method that makes the map distinct can be used. The path displayed by the path display 234 will be described with reference to FIGS. 3 and 4.

FIG. 3 is a diagram illustrating an example of arrangement of lighting devices in a store; and FIG. 4 is a diagram illustrating an example of a method of guiding the location of a product of interest.

Referring to FIGS. 3 and 4, display shelves are arranged in the store and each display shelf has a lighting device installed thereon. Referring back to FIG. 1, each lighting device 500 communicates with the lighting management server 100 through the repeater 300. The lighting management server 100 compiles location information of each product, relative to locations of lighting devices, into a database, and manages the database. More specifically, the management server 100 manages matching information between a location of each lighting device and a location of each display shelf.

Referring to FIG. 4, a path from a current location 410 of a terminal device to a location 420 of a product of interest is displayed on a display.

An identification number of a product is matched with an identification number of a lighting device, and the location of the lighting device is determined by the identification number thereof. Therefore, once the identification number of a product is known, it is possible to obtain a matched identification number of a lighting device, whereby the location of the lighting device can be identified. That is, once the location of the lighting device is identified, the location of the display shelf matched with the lighting device is also identified, so that a customer can find where the product of interest is located.

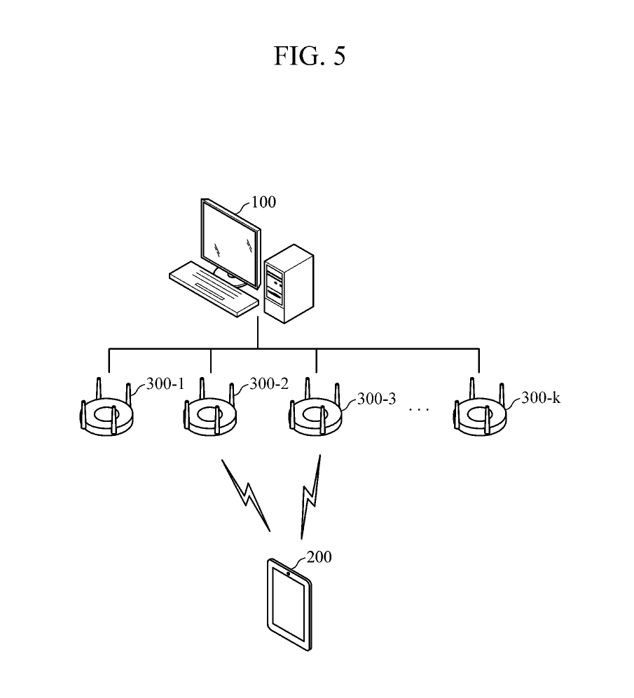

FIG. 5 is a diagram illustrating an example for explaining a method of a terminal device to estimate a current location thereof.

In the example, the terminal location calculator 233 is a triangulation module to compute the current location of the terminal device 200 via triangulation process using wireless communication with at least two repeaters.

Referring to FIG. 5, a current location of the terminal device 200 is computed by the triangulation module. For example, the terminal location calculator 233 may compute the current location of the terminal device 200 via triangulation using wireless communication with two repeaters 300-2 and 300-3 (refer to FIG. 1).

Triangulation is to compute a location of interest using distances among three points. The triangulation may use received signal strength indication (RSSI) or information about time of arrival (TOA). The RSSI-based triangulation may compute a location of a device terminal using the fact that as a distance between the repeater and the terminal device increases, the received signal strength is reduced. The TOA-based triangulation computes a location of the terminal device by converting a difference between a time at which the terminal device transmits location information thereof to the repeater and a time at which the repeater receives the location information into a distance.

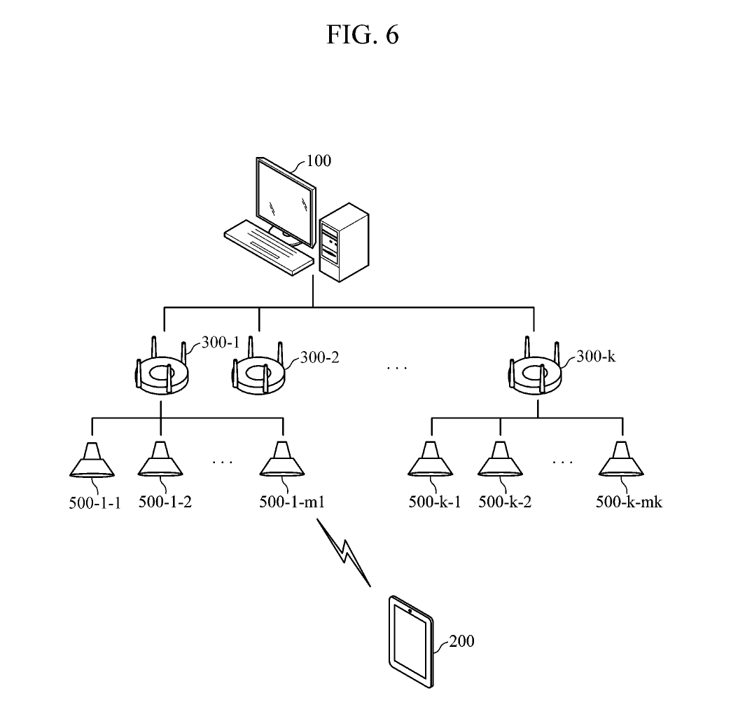

FIG. 6 is a diagram illustrating another example for explaining a method of a terminal device to estimate a current location thereof.

In the example, the terminal device 200 may further include a near-field communicator 250 that communicates with lighting devices in the store. In this example, the terminal location calculator 233 is a lighting location calculator that obtains identification information of a lighting device through the near-field communicator 250, acquires location information of the lighting device from the obtained identification information, and computes the current location of the terminal device 200. Each lighting device 500 may be an LED lighting device having a communication IC embedded therein for wireless control.

Referring to FIG. 6, the current location of the terminal device is computed by the lighting location calculator. The terminal device 200 may further include the near-field communicator 250 that communicates with the lighting devices 500 in the store. The near-field communicator 250 may be any of the following: NFC, WiFi, and ZigBee modules.

The terminal device 200 may be any type of portable terminal device that is capable of implementing various functions using applications as well as wireless communication, and examples thereof may include a personal mobile communication services terminal, a personal digital assistant (PDA), a smartphone, a tablet computer, a laptop computer, a wireless LAN terminal device, a shopping guidance device equipped on a cart in the store, and a hand-held device offered by the store.

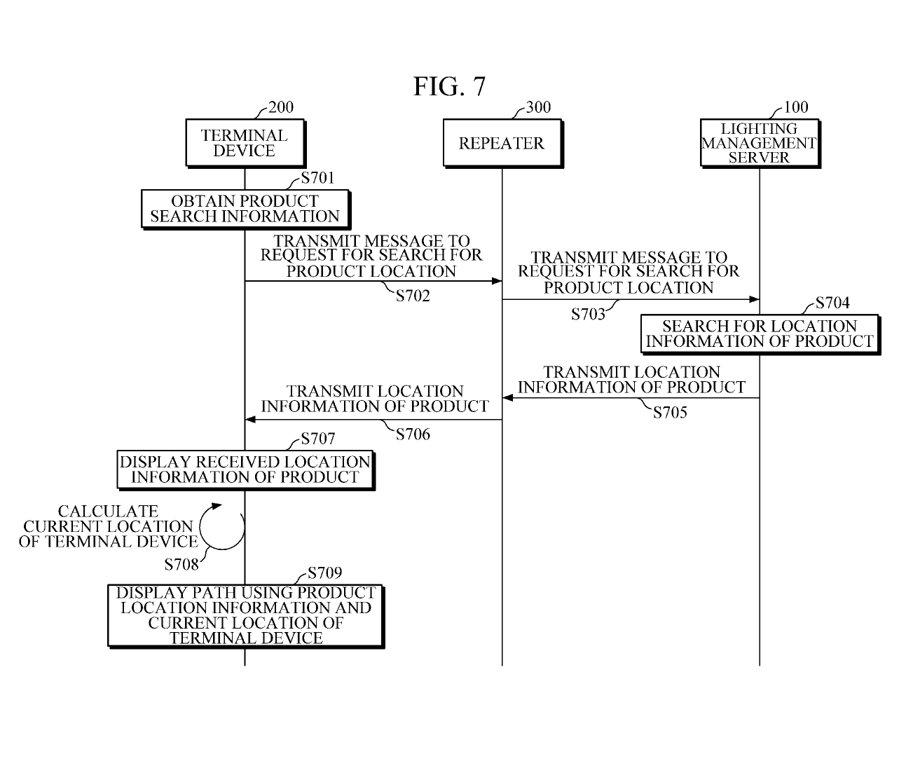

FIG. 7 is a flowchart illustrating a method of showing a direction to a product of interest according to an exemplary embodiment.

Referring to FIG. 7, the method of showing a direction to a product of interest includes the following operations of: obtaining at a terminal device 200 product search information from a user in S701; generating a message to request for search for a product location in S702; transmitting the generated message to a lighting management server 100 via a repeater 300 in S703; the lighting management server searching for identification information of a lighting device in response to the product location request message and searching for location information of product corresponding to the found identification information of lighting device in S704; transmitting the found location information of product from the lighting management server 100 in S705 to the terminal device 200 through the repeater 300 in S706; and displaying at the terminal device 200 the received location information of product in S707.

The procedures described below will be implemented in various embodiments. The method shown in FIG. 7 may be implemented by the terminal device 200 shown in FIG. 2 in the lighting management system shown in FIG. 1. To avoid redundancy, the same descriptions as those provided with reference to FIGS. 1 to 6 will not be reiterated.

In one example, the method may further include operations of the terminal device 200 calculating its current location in S708 and generating an image of a path from the current location of the terminal device 200 to the location of a product of interest based on the received location of the products and displaying the generated image in S709.

In the example, in S708 in which the current location of the terminal device 200 is calculated, triangulation is performed using a wireless communication with at least two repeaters.

In another example, in S708, the terminal device 200 may obtain identification information of a particular lighting device through a near-field communication with the lighting device, acquire location information of the lighting device from the obtained identification information, and calculate the current location of the terminal device 200. At this time, the near-field communication may be one or more of the following communications: NFC, WiFi, and ZigBee communications.

According to the above exemplary embodiments, it is possible to search for a location of a product of interest in a store using a terminal device.

Also, it is possible to show a path from a current location of a terminal device to a location of a product of interest.

Moreover, it is possible to reduce the time for product search in the store.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A terminal device for providing location information of product of interest in association with a lighting management system that comprises a plurality of groups of lighting devices, a plurality of repeaters that establish near-field communications with the respective groups of lighting devices, and a lighting management server that controls the lighting devices through the repeaters, the terminal device comprising:
a communicator configured to communicate with the repeaters;
a display configured to display information visibly;
a storage module configured to store the information;
a product location searcher configured to generate a message to request search for a location of a product of interest based on received product search information that is input by a user, transmit the message to the lighting management server through the repeater, and receive product location information that is specified as a location of a lighting device in proximity to the product of interest through the repeater; and
a controller configured to generate product-location-representation information that displays an overlay of the received product location on a map and display the generated information on the display.

2. The terminal device of claim 1, wherein the controller comprises
a terminal location calculator configured to compute current location information of the terminal device and
a path display configured to compute a path from the location of a product of interest received from the product location searcher and the current location computed by the terminal location calculator, generate an image of the generated path and display the generated image on the display.

3. The terminal device of claim 2, wherein the terminal location calculator computes the current location of the terminal device through triangulation using a wireless communication with at least two repeaters.

4. The terminal device of claim 2, further comprising:
a near-field communicator configured to communicate with the lighting devices in a store,
wherein the terminal location calculator obtains identification information of lighting device through the near-field communicator, acquires location information of the lighting device based on the obtained identification information and computes the current location of the terminal device based on the acquired location information of the lighting device.

5. The terminal device of claim 4, wherein the near-field communicator is at least one of following modules: NFC, WiFI, and ZigBee modules.

6. A method of showing a direction to a product of interest, comprising:
receiving, at a terminal device, product search information from a user, generating a message to request search for a location of a product of interest, and transmitting the generated message to a lighting management server through a repeater;
the lighting management server searching for an identification number of lighting device in response to the message transmitted from the terminal device, and searching for location information of product that corresponds to the found identification information of the lighting device;
transmitting the found location information of the product from the lighting management server to the terminal device through the repeater; and
displaying, at the terminal device, the received location information of the product.

7. The method of claim 6, further comprising:
the terminal device computing its current location; and
the terminal device computing a path from the received location of a product of interest and the computed current location of the terminal device, generating an image of the generated path and displaying the generated image.

8. The method of claim 7, wherein in the calculating of the current location of the terminal device, triangulation is performed using a wireless communication with at least two repeaters.

9. The method of claim 7, wherein the current location of the terminal device is calculated by obtaining identification information of a lighting device through a near-field communication with the lighting device and acquiring location information of the lighting device based on the obtained identification information.

10. The method of claim 9, wherein the near-field communication is one or more of the following communications: following communications: near-field communication (NFC), WiFi, and ZigBee communications.
